(19) United States
(12) Patent Application Publication
(10) Pub. No.: US 2006/0092077 A1
(43) Pub. Date: May 4, 2006

(54) Antenna having inclined conductive branch

(75) Inventor: Dong Sheng Zhou, Chongli (TW)

Correspondence Address: CHARLES E. BAXLEY, ESQ., 90 JOHN STREET, THIRD FLOOR, NEW YORK, NY, 10038, US

(73) Assignee: Joymax Electronics Co. , Ltd.

(21) Appl. No.: 10/980,531

(22) Filed: Nov. 3, 2004

(51) Int. Cl. H01Q 1/38

(52) U.S. Cl. 343/700 MS

(57) ABSTRACT

An antenna includes a ground plate, a conductive branch having a conductor feed extended for electrically coupling to the ground plate, and a cable electrically coupled to the conductor feed for signal transmitting and receiving purpose. The conductive branch is inclined relative to the conductor feed and the ground plate, for increasing signal transmitting and receiving directions and frequency range for the antenna, and for avoiding dead angles for the antenna. One or more conductor extensions may be electrically coupled between the conductor feed and the ground plate, for increase a signal transmitting and receiving or communicating path between the conductive branch and the ground plate.

### BACKGROUND OF THE INVENTION

1. Field of the Invention

The present invention relates to an antenna, and more particularly to an antenna having an inclined conductive branch for increasing or facilitating signal transmitting and receiving angles or directions, and for avoiding dead angles.

2. Description of the Prior Art

Various kinds of typical antennas have been developed for wireless signal transmitting and receiving purposes, and comprise one or more conductive branches extended from signal feeds, for wireless communication purposes.

For example, U.S. Pat. No. 6,529,749 to Hayes et al., and U.S. Pat. No. 6,570,538 to Väisänen et al. disclose two of the typical antennas each also comprising one or more signal feeds or conductors extended from a circuit board or a ground plate, and one or more conductive branches extended from the signal feeds or conductors, for wireless communication purposes, and for signal transmitting and receiving purposes.

However, in the typical antennas, the signal feeds or conductors and the conductive branches are perpendicular to each other, such that the signal transmitting and receiving angles or directions of the conductive branches are limited, and such that dead angles for signal transmitting and receiving purposes will be formed or generated, and such that the frequency range may also be limited or narrowed.

The present invention has arisen to mitigate and/or obviate the afore-described disadvantages of the conventional antennas.

### SUMMARY OF THE INVENTION

The primary objective of the present invention is to provide an antenna including an inclined conductive branch for increasing or facilitating signal transmitting and receiving angles or directions, and for avoiding dead angles, and/or for increasing frequency range for the antenna.

In accordance with one aspect of the invention, there is provided an antenna comprising a ground plate, a conductive branch, the conductive branch including a conductor feed extended therefrom, for electrically coupling to the ground plate, and a cable electrically coupled to the conductor feed for signal transmitting and receiving purpose. The conductive branch is inclined relative to the conductor feed, and thus being inclined relative to the ground plate, and for preventing the conductive branch from being completely parallel to the ground plate, and for increasing signal transmitting and receiving directions and frequency range for the antenna, and for avoiding dead angles for the antenna.

The ground plate includes at least one first conductor extension extended therefrom for electrically coupling to the conductor feed. The first conductor extension is perpendicular to the ground plate.

The ground plate includes a second conductor extension extended from the conductor extension and electrically coupled to the conductor feed. The second conductor extension is perpendicular to the conductor extension and the conductor feed.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an antenna in accordance with the present invention;

FIG. 2 is a perspective view of the antenna, illustrating the operation of the antenna;

FIG. 3 is a graph illustrating an operating performance of the antenna; and

FIGS. 4, 5, 6 are charts illustrating the performance of the antenna.

### DETAILED DESCRIPTION OF THE PREFERRED EMBODIMENT

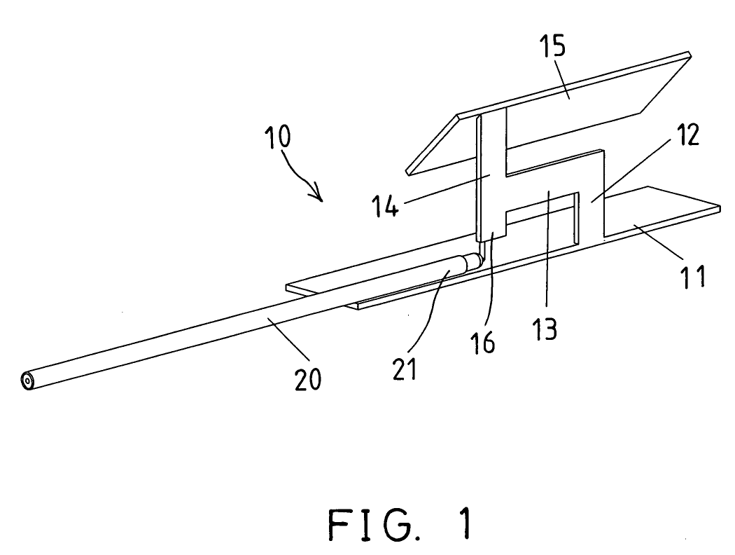

Referring to the drawings, and initially to FIG. 1, an antenna 10 in accordance with the present invention comprises a ground plate 11, a vertical conductor extension 12 extended from the ground plate 11, such as extended upwardly from the ground plate 11 and perpendicular to the ground plate 11, and another or a horizontal conductor extension 13 extended laterally from the vertical conductor extension 12 and perpendicular to the vertical conductor extension 12, such that the horizontal conductor extension 13 is also parallel to the ground plate 11.

The antenna 10 further includes a conductor feed 14 extended from the horizontal conductor extension 13 and perpendicular to the horizontal conductor extension 13, such that the conductor feed 14 is also perpendicular to the ground plate 11 and parallel to the vertical conductor extension 12. The antenna 10 further includes a conductive branch 15 extended from the conductor feed 14 and inclined relative to the conductor feed 14, and thus electrically coupled to the ground plate 11 via the horizontal conductor extension 13 and the vertical conductor extension 12.

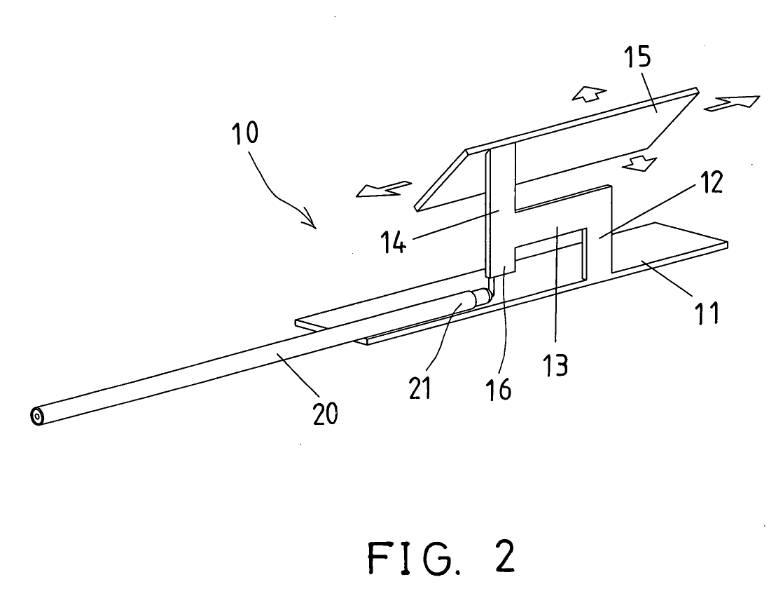

It is to be noted that the conductive branch 15 of the antenna 10 is inclined relative to the conductor feed 14, and also inclined relative to the horizontal conductor extension 13 and the vertical conductor extension 12 and the ground plate 11, such that the conductive branch 15 may be directed toward various angles or directions relative to the conductor feed 14 and the horizontal conductor extension 13 and the vertical conductor extension 12 and the ground plate 11, best shown in FIG. 2.

The antenna 10 further includes a cable 20, such as a radio frequency cable 20 having one end 21 electrically coupled to a free end 16 of the conductor feed 14, and thus electrically coupled to the conductive branch 15, for signal transmitting and receiving purposes. It is to be noted that the provision or the extension of the conductor feed 14 and the horizontal conductor extension 13 and the vertical conductor extension 12 between the conductive branch 15 and the ground plate 11 may increase a signal transmitting and receiving or signal communicating path between the conductive branch 15 and the ground plate 11.

In operation, as shown in FIG. 2, due to the inclination of the conductive branch 15 relative to the conductor feed 14 and the horizontal conductor extension 13 and the vertical conductor extension 12 and the ground plate 11, the conductive branch 15 will not be completely parallel to the conductor feed 14 and the horizontal conductor extension 13 and the vertical conductor extension 12, such that the conductive branch 15 may be directed toward various angles or directions for increasing or facilitating signal transmitting and receiving angles or directions, and for avoiding dead angles, and/or for increasing frequency range for the antenna.

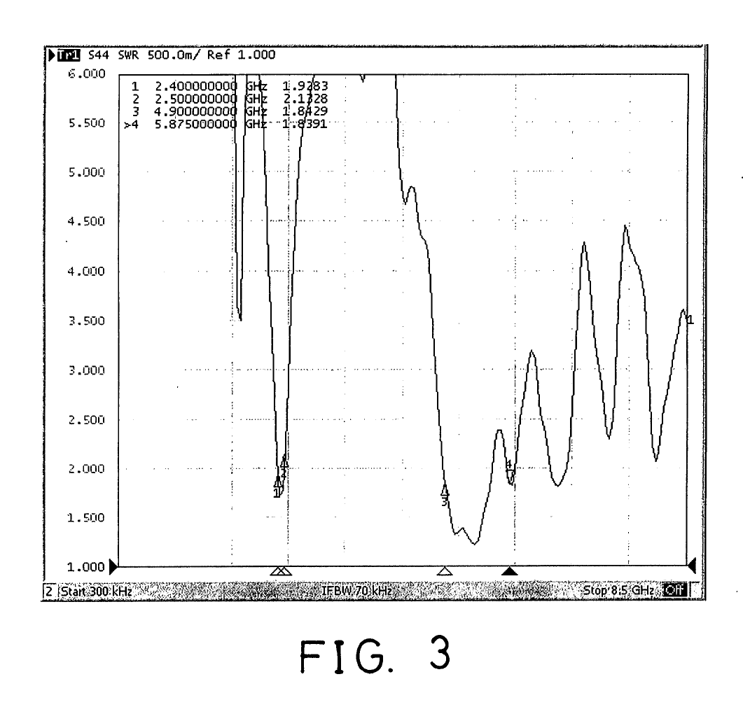

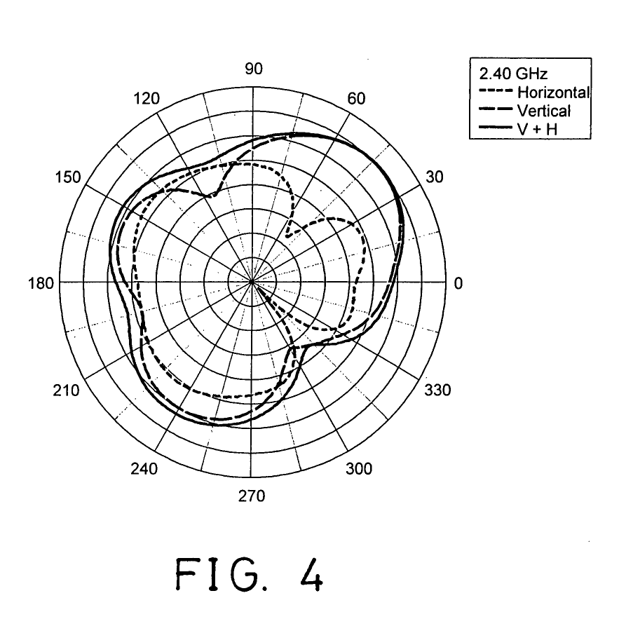

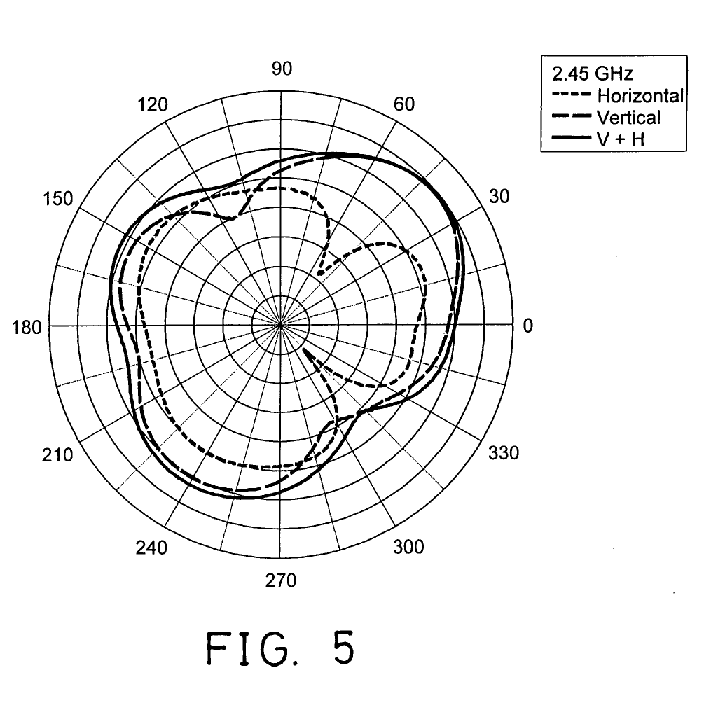

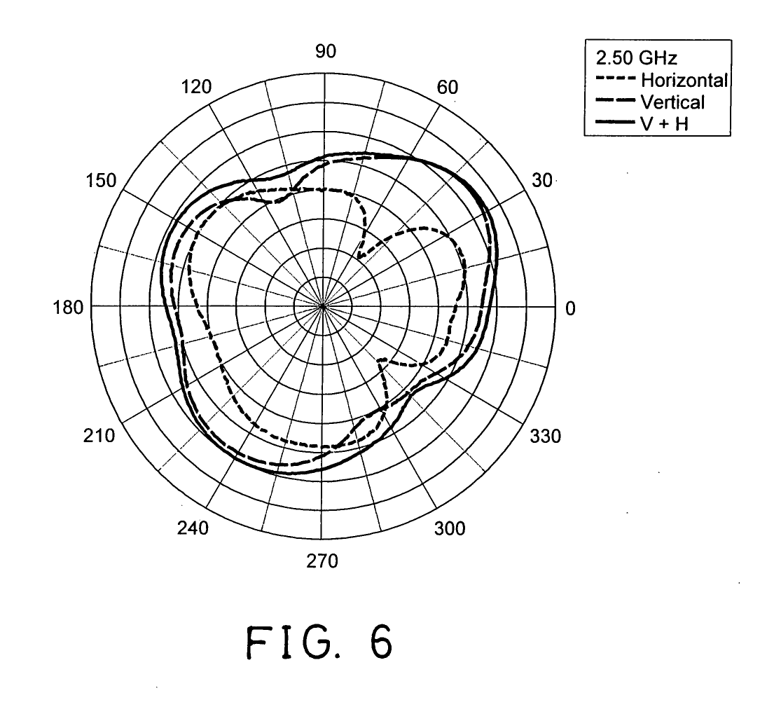

As shown in FIGS. 3-6, illustrated are the testing results of the antenna 10 with different frequencies, the signal transmitting and receiving angles or directions and/or the frequency range for the antenna may be increased or facilitated, such that the influence of the antenna 10 by the environment may be decreased.

It is further to be noted that the conductive branch 15 may also be directly coupled to the ground plate 11 with the conductor feed 14, without the horizontal conductor extension 13 and the vertical conductor extension 12, to slightly decrease the signal transmitting and receiving or signal communicating path between the conductive branch 15 and the ground plate 11.

Accordingly, the antenna in accordance with the present invention includes an inclined conductive branch for increasing or facilitating signal transmitting and receiving angles or directions, and for avoiding dead angles, and/or for increasing frequency range for the antenna.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna comprising:
a ground plate,
a conductive branch,
said conductive branch including a conductor feed extended therefrom, for electrically coupling to said ground plate, and
a cable electrically coupled to said conductor feed for signal transmitting and receiving purpose,
said conductive branch being inclined relative to said conductor feed, and thus being inclined relative to said ground plate, for increasing signal transmitting and receiving directions and frequency range for said antenna, and for avoiding dead angles for said antenna.

2. The antenna as claimed in claim 1, wherein said ground plate includes at least one first conductor extension extended therefrom for electrically coupling to said conductor feed.

3. The antenna as claimed in claim 2, wherein said at least one first conductor extension is perpendicular to said ground plate.

4. The antenna as claimed in claim 2, wherein said ground plate includes a second conductor extension extended from said at least one conductor extension and electrically coupled to said conductor feed.

5. The antenna as claimed in claim 4, wherein said second conductor extension is perpendicular to said at least one conductor extension and said conductor feed.
